(19) United States
(12) Patent Application Publication
(10) Pub. No.: US 2022/0161706 A1
(43) Pub. Date: May 26, 2022

(54) VEHICLE WITH CARPET CLEANING EQUIPMENT

(71) Applicant: TriArc Incorporated, Lamar, SC (US)

(72) Inventors: Ray Smith, Lamar, SC (US); Aaron Zills, Albert Lea, MN (US)

(21) Appl. No.: 17/669,253

(22) Filed: Feb. 10, 2022

Related U.S. Application Data
(63) Continuation of application No. 16/752,600, filed on Jan. 24, 2020.
(60) Provisional application No. 62/796,414, filed on Jan. 24, 2019.

(51) Int. Cl. B60P 3/14; B60P 3/22

(52) U.S. Cl. CPC B60P 3/14; B60P 3/2215; A47L 11/4088; B60P 3/2265; B60P 3/225

(57) ABSTRACT

A vehicle with a carpet cleaning system comprises a plurality of operational units mounted within the vehicle, including a blower pump unit, a vacuum recovery tank unit, a reel and tank unit, and an auxiliary tank unit. The operational units are mounted on a stainless steel mounting frame that defines zones for mounting each of the operational units. The mounting frame having attachment points that align each of the respective operational units which facilitates the initial assembly of the unit. The mounting frame is secured to the floor through a minimal number of opening extending through the floor. The operational units are secured with a multiplicity of threaded connectors to the frame. The separation of the individual operational units from direct attachment to the floor dramatically reduces corrosion of the vehicle and equipment, facilitates the initial assembly and minimizes maintenance and repairs.

### CROSS-REFERENCE TO RELATED APPLICATIONS

This application is a continuation of U.S. patent application Ser. No. 16/752,600 filed Jan. 24, 2020, which claims the benefit of U.S. Provisional Application No. 62/796,414, filed Jan. 24, 2019, both of which are herein incorporated by reference in their entireties.

### FIELD OF THE INVENTION

The invention relates to trucks and vans with carpet and floor cleaning systems having a plurality of separately mounted operational units installed in the vehicle.

### BACKGROUND OF THE INVENTION

Of the many floor cleaning systems available for commercial and residential use, a major segment are truck or van mounted carpet and floor cleaning systems. The vehicle in these systems are parked outside the residence or facility with a floor to be cleaned and hoses are extended from the vehicle into the building. The hoses are attached to cleaning tools the inside the building. The hoses include a dispense hose for conveying cleaning fluid to the floor or other substrate to be cleaned and a vacuum hose to convey the cleaning fluid sucked from the floor or substrate back to the vehicle to be stored in a tank. The systems installed in the vehicle have several operational components that are manufactured as a plurality of separate discrete operational units, typically three or four, that are each individually installed into a vehicle by individually mounting each to the floor of vehicles and then interconnected as necessary with wiring, hoses, etc. Each one of the discrete operational units may combine one or more operational functions. The operational components are interconnected including a fluid pump, a blower for creating a suction, a suction tank for storing the retrieved cleaning fluid, a water or cleaning fluid tank, an auxiliary tank, reels for storing the hoses, a control panel, and a drive system for the fluid pump and blower. The installation of each discrete operational unit involves placement of the unit on the vehicle floor in a proper positioning; locating, marking and drilling multiple holes through the vehicle floor that correspond to mounting holes on the operational unit's mounting flanges; and then bolting the unit to the floor by extending bolts through the unit's flange and through the vehicle floor. The positioning, drilling holes in the vehicle floor, bolting is done sequentially for each operational unit. The operational units are then interconnected with appropriate wiring and hoses to each other and to the vehicle systems.

Particularly when the floor cleaning systems are mounted in vans, the drive system for the pump and blower can be a direct drive from the vehicle engine. Such direct drive utilizes a clutch unit with a pulley mounted at the vehicle engine and connected to the main drive belt of the vehicle.

A drive shaft extends from the clutch unit to a position above the floor and between the driver and passenger seats. Some systems utilize a separate internal combustion engine in the cargo area to drive the pump and blower.

FIGS. 1A-7 depict prior art known equipment associated with vehicle mounted carpet cleaning equipment. FIGS. 1A and 1B illustrates a cargo van 10 with a direct drive carpet cleaning system 12 is installed therein. FIG. 1B depicts the cargo van 10 with the roof removed that is suitable for embodiments disclosed herein. The cargo van has a cab 30 with a cab area 32 including a driver's seat 34 and a passenger seat 36. Rearward of the cab is a cargo box 42 having side walls 44, 46 a cargo box floor 48 with ribbing 49, and a side access door 50. The van also has a rear cargo access door 52. The carpet cleaning system comprises several operational units 14 each directly and separately attached to the floor of the van. The operational units are interconnected such as by wiring and hoses. The direct drive system utilizes a clutch unit 66 that is connected to the main engine drive belt of the van engine, not shown. Driveshaft 68 extends from the clutch to a blower pump unit 70 mounted directly to the floor of the van, see also FIG. 3. The pump 71 of the blower pump unit pumps the cleaning fluid to the cleaning site. The blower 72, depicted in FIGS. 1A and 5, providing the suction for the cleaning fluid recovery. The blower suction side is connected to a vacuum recovery tank unit 74 separately mounted to the floor of the van. The vacuum recovery tank unit 74 also has an operator control panel 75. A hose reel and liquid storage tank unit 80 is depicted in FIG. 1A as positioned directly rearward of the vacuum recovery tank unit 74 and is individually attached to the floor 48. The unit may have a manual or powered reel for a vacuum hose and a reel for a fluid dispensing. An auxiliary liquid tank unit 86 (FIG. 1) is positioned in the rearward cargo area of the van.

Operational units that may be combined to form a complete vehicle mounted carpet cleaning system are available from various manufacturers. Individual operational units may combine a plurality of the functionalities associated with carpet cleaning. Such integrated operational units will typically have a chassis supporting components and include steel apertured mounting strips 90 or tabs for bolting the particular unit to floors of vehicles. Such operational units for truck or van mountable cleaning systems are available from various manufacturers. The operational units portrayed in FIGS. 3-7, generally reflect units available from Hydramaster Corporation, Mukilteo, Wash. Hydramaster also manufactures kits for adding the clutch and direct drive systems to vehicles. Other manufacturers' operational units will have particular functionalities differently arranged.

A problem common with van installed floor cleaning systems, particularly direct drive cleaning systems, is that installation of the systems is time and labor intensive. Conventional installation can require one week of time with at least two people at all stages of the installation and one week. The installation of the systems requires bolting each of the operational units directly to the floor of the vehicle. A conventional installation of the direct drive systems with an auxiliary tank as illustrated in FIGS. 1A and 1B, can require more than twenty holes drilled in the vehicle floor for individual mounting each of the four operational units. This present difficulties when there is a need for maintenance and/or removal of the individual operational units.

A further issue is the number of drilled holes in the floor of the vehicle that are required for installation and that each of the components is bolted to the floor individually. Although trucks may have flat wood floors that avoid floor corrosion issues, van systems typically have ribbed steel floors. Attachment of the mounting strips of the operational units to the ribbed floors can problematic. The systems utilize large quantities of water and other cleaning fluids. Over time, such fluids spill or leak onto the floor of the vehicle. Referring to FIG. 2, conventional mounting of the operational units 14 with mounting strips 90 allows for multiple locations for water to sit and makes removal of the fluids difficult. Additionally, the numerous drilled holes in the van floor for attaching the separate units, typically more than twenty, increases susceptibility to rust for both the vehicle and the components/equipment sitting in pooled water. Rust can begin to form in a short amount of time when the vehicles are used in regions where salt is used as a deicer on roads. The corrosion problem may be greatly enhanced when the cleaning fluids are corrosive, including for example systems where salt water and/or ionized water is utilized. Each of the holes through the floor provides a potential corrosion site. Once the steel floor starts to corrode, the steel framework and housings associated with the operational units, and the threaded fasteners, also may corrode. Removal of nuts or the like for equipment removal below the floor can be problematic. Moreover, with each of the components bolted to the floor individually, there is less than optimal weight distribution, particularly for the heaviest units, such as full fluid tanks, providing localized stress points on the vehicle floor. Such stress combined with corrosion can lead to failure of the integrity of the floor. Removal and repair of the operational units, repair of the vehicle floor, monitoring and repair of corrosion sites, replacement of the vehicle all may require considerable time, manpower and expense. Obviously, the loss of the use of the vehicle can cause loss of business. Where a business has a fleet of vehicles, such problems and impact on the business can be multiplied resulting in significant economic loss dramatically impacting margins.

Any improvements in installation time of, particularly direct drive systems, would be welcomed by the floor cleaning industry. Any improvements in preventing and monitoring corrosion to vehicles and floor cleaning system operational units would be welcomed by the floor cleaning industry. Any improvements in ease of maintaining vehicles with floor cleaning would be well received by the industry. Any improvements in the ease of removal of operational units of cleaning systems mounted in vans would be welcomed by the industry.

### SUMMARY OF THE INVENTION

In embodiments, a frame assembly for supporting and securing a plurality of separate discrete operational units of a floor cleaning system onto a common frame is installed in a cargo van. The separate operational units attachable to the frame assembly with threaded fasteners at predrilled or studded locations matching attachment holes on mounting flanges of the units. The frame assembly attachable to a floor of the van in the cargo area with a minimal number of bolts penetrating the floor. The frame assembly formed of a plurality of stainless steel rectangular tubular members welded together. The frame assembly including an opposing pair of elongate linear forward-rearward extending side frame portions and a plurality of crossing portions arranged perpendicular to the linear side frame portions. The crossing portions welded to side frame members forming one or more closed polygons. Each of the operational units mounted and seated on the frame assembly and not directly mounted to the floor of the van whereby the entirely of the weight of each of the operational units is supported by the frame assembly.

In embodiments, a direct drive cleaning system in a van comprises at least three discrete operational units that together provide for pumping out cleaning or rinse liquid, recovery by suction of used cleaning or rinse liquid, unused cleaning or rinse liquid storage, recovered cleaning or rinse liquid storage, dispense liquid hose storage, and vacuum suction hose storage. Each of the plurality of units are attached to an integrated or unitary metal frame formed of a plurality of corrosion resistant tubing members comprising forward-rearward metal frame members and transverse metal frame members welded together forming a plurality of closed polygonal shapes. The frame mounted immediately rearward of the driver and passenger seats and spanning substantially the distance between the opposite sidewalls of the van in the cargo area of the van.

A pair of forward-rearward extending frame portions extend in close proximity to van walls, for example within 6 inches, in embodiments within 4 inches. In embodiments, at least two floor attachment points is in a frame portion most adjacent to a side wall of the van. In embodiments, a blower/pump unit support frame with a rectangular shape extends forward from a top side of a van transverse member, the blower/pump unit displaced from each of the forward corners.

In embodiments, a unitary stainless steel frame nests together at least three separate discrete operational units of a floor cleaning system in the forwardmost region of the cargo area of a van. The van having an engine, driver's compartment with a driver's seat, a passenger compartment with a passenger seat, a van enclosure with side walls and a ceiling defining a rear cargo area, a side entrance rearward of the passenger seat opening to the cargo area, the side entrance having at least one side door, a rear cargo entrance with a pair of rear doors for opening and closing the rear cargo entrance. A steel cargo area floor extending from the driver's compartment and passenger compartment through the cargo area to the side entrance and to the rear cargo entrance. The cargo area having a length extending from the driver's compartment and passenger compartment to the rear entrance and a width extending between the sidewalls. The unitary frame having a planar lower surface that distributes the weight of the at least three separate discrete operational units about the floor of van.

In embodiments, each operational unit having a mounting footprint with opposing linear mounting strip portions with a plurality of mounting holes on the mounting footprint. The frame assembly having cooperating attachment portions of the mounting strips positioned on the frame assembly corresponding to the mounting holes. The bottom horizontal surface of the mounting strip being flush with the top horizontal planar surface of the frame mounting assembly.

In embodiments, the frame assembly may further include a rearward elevating framework for an auxiliary water tank. The water tank supported by the elevating framework, the elevating framework attached to the top side of frame assembly. In embodiments the elevating framework seated and mounted on the rearwardmost crossing frame portion and adjoining rearward portions of the side frame portions. The elevation providing a head for the water or other liquid in the tank.

In embodiments, a frame assembly for supporting and securing a direct drive truckmount cleaning system in a vehicle. The direct drive truckmount cleaning system may comprise a blower and pump assembly, a recovery tank assembly, a hose reel and tank assembly and a water tank. The frame assembly may have a forward portion, a rearward portion and an upper mounting surface and a bottom surface. In embodiments, the frame assembly may be configured for securement to the floor of the vehicle and for securement of the direct drive truckmount cleaning system to the top mounting surface, the bottom surface rests on the floor, such that the direct drive truckmount cleaning system is positioned above the floor of the vehicle and the weight of the a blower and pump assembly, a recovery tank assembly, a hose reel and tank assembly and a water tank are distributed about the floor by the frame assemble.

In embodiments, a frame assembly for supporting and securing components of a direct drive truckmount cleaning system in a vehicle for transport and use, such that, when the direct drive truckmount cleaning system is secured on the frame assembly, the cleaning system is elevated above the floor of the vehicle.

In embodiments, a frame assembly for supporting and securing a direct drive truckmount cleaning system in a vehicle. The direct drive truckmount cleaning system may comprise a blower and pump assembly, a vacuum recovery tank assembly, a hose reel and tank assembly and a water tank. The frame assembly may have adjacent mounting zones oriented along the length of the frame assembly. The width of the frame assembly at each mounting zone specifically adapted for the specific unit to be mounted thereon. The frame assembly is configured for securement to the floor of the vehicle. In embodiments, the forward most first support mounting zone defined by a rectangular frame portion configured to receive and secure the blower and pump assembly, the first mounting zone. A second mounting zone adjacent to and rearward of the first mounting zone is sized and configured to receive and secure the vacuum recovery tank assembly, a third zone adjacent to and rearward of the second zone is sized and configured to receive and secure the hose reel and tank assembly, and a fourth zone adjacent to and directly rearward of the third zone is configured to receive and secure an auxiliary water tank. The side to side width of the first zone being less than the side to side width of the second zone. The rectangular frame portion for the blower and pump unit positioned between a driver's seat and a passenger seat. The side to side width of the second mounting zone being less than the side to side width of the third mounting zone. The side to side width of the fourth mounting zone being equal to the side to side width of the fourth mounting zone.

In embodiments, the frame assembly is configured for securement and is secured to the floor of the vehicle by no more than six bolts. In an embodiment, the frame assembly is configured for securement and is secured to the floor of the vehicle by no more than four bolts. A feature and advantage of using minimal number of bolts through the floor is that optimal attachment points may be selected along the frame portions of the mounting frame assembly. Such attachment points can be at structurally advantageous points, such as near wall struts.

Additionally, cargo van floors steel floors have longitudinal ribbing running forwardly and rearwardly in the cargo area. The ribbing defines plateaus and valleys which is very beneficial for adding structural strength to the floor. The inventors have recognized that with the placement of operational units with mounting strips directly on the cargo box floor, the ribbing can be problematic. The mounting strips may not be seated perfectly on a rib causing attachment holes to be drilled through non-horizontal portions. Or the placement of the mounting strips of the operational units may end up not fully positioned on the plateaus, particularly where the mounting strips run parallel to the ribbing. This can cause instability and damage to the equipment mounting flanges, for example bending. Such bending may cause failure of the paint/coating of the flanges thereby providing a starting point of corrosion. Moreover, mounting the mounting strips of the operational units in the valleys creates isolated regions that retain debris and liquids and thereby are not amenable to cleaning and drying out. This also can dramatically contribute to increased corrosion of the cargo box floor and attached equipment. With the stainless steel mounting frame assembly having a planar lower surface on the frame portions, two inches wide, and with frame portions running transverse to the ribbing as well as forward-rearwardly, parallel to the ribbing, there the frame assembly simply cannot extend into the depressions. An entire integrated or unitary assembly comprising of welded rectangular tubing is bolted to the ribbed floor rather than discrete tabs or sheet metal mounting flanges. This facilitates cleaning and drying and minimizes opportunity for corrosion on the floor and on the operational unit mounts. A feature and advantage of the mounting frame assembly is that the mounting strips on received flush on the planar top mounting surface, there are no mechanisms for bending or damaging the mounting strips of the operational units.

Selecting an attachment point of a plateau rather than a valley minimizes the chances of cleaning solution pooling at the attachment point. In embodiments, each floor attachment includes a stainless steel bolt, a stainless steel plate with a central aperture below the floor that the bolt extends through and a stainless steel nut. In embodiments, the plate may be at least 18 inches in area.

A feature and advantage of embodiments is an improved method of installing a direct drive truckmount cleaning system in a cargo van. The cleaning system having a plurality The method may comprise: providing a van with a cargo area and an open floor; adapting the van with a direct drive including a driveshaft extending to between the passenger and drivers seat; installing and securing a main frame portion of a frame assembly having a first frame portion and a second frame portion forward of the first frame portion; mounting and securing a blower system on the second frame portion above the floor, mounting and securing a hose reel and tank assembly on the first frame portion above the floor; mounting and securing a recovery tank assembly on the first frame portion rearward of the blower assembly, above the floor; and mounting and securing a water tank on a rear frame of the frame assembly and mounting securing the rear frame on a rearward portion of the first frame portion. In embodiments, each component of the direct drive truckmount cleaning system is mounted and secured in a separate mounting portion of the frame assembly.

A feature and advantage of embodiments is that rectangular stainless steel tubing 1.0×2.0 inches is utilized for floor contacting portions of the frame assembly with the greater dimensioned sides on the top and bottom of the frame portions elevating the cleaning system only an inch off of the floor. This minimal elevation does not significantly impact the center of gravity of the vehicle thereby not detrimentally effecting the stability of the vehicle. The 1.0 inch equipment elevation has been found to be adequate for separating the cleaning equipment from any potential pooling of liquids on the floor and it is believed to have sufficient rigidity for effective weight transfer along the respective lengths of the frame portions. A feature and benefit of embodiments is that the mounting frame assembly elevates operational units of the cleaning system at least 0.75 inches but not more than 1.5 inches above the cargo box floor. A feature and benefit of embodiments is that the mounting frame assembly elevates operational units of the cleaning system at least 0.75 inches but not more than 2.5 inches above the cargo box floor. A feature and benefit of embodiments is that the mounting frame assembly elevates operational units of the cleaning system at least 0.45 inches but not more than 3.1 inches above the cargo box floor.

In embodiments, solid stainless steel members with rectangular cross sections may also be utilized for the frame portions. In embodiments, other corrosion resistant metals, such as aluminum, or even steel frame portions may be utilized in embodiments with suitable corrosion protection.

In embodiments, a stainless steel platform is mounted on the ribbed steel floor of a cargo van. The platform having a mounting surface or surfaces elevated from the steel floor, the platform having defined zones for receiving operational units of a carpet cleaning system. The zones defined by threaded fastener portions positioned in alignment with mounting holes of the plurality of operational units whereby the platform may be mounted on the ribbed steel floor with a minimal number of fasteners extending through the ribbed steel floor and each of the operational units are separately mounted to the platform utilizing threaded fasteners. The platform formed of a corrosion resistant metal and operative to distribute the collective weight of the operational units about the ribbed steel floor corresponding to the area of the platform and/or the area of the floor contacted by the platform.

In embodiments, a plurality of corrosion resistant floor contacting rails span across the a cargo van with a ribbed steel floor, stainless steel receiving members with planar upper surfaces are connected to the plurality of corrosion resistant floor contacting rails and are positioned to align with the mounting strips of a plurality of operational units of a carpet cleaning system. Whereby the operational units are mounted to the corrosion resistant receiving members by threaded fasteners extending through apertures in the operational units' mounting strips and into or through the receiving members. Bottom planar surfaces of the mounting strips seated on upward facing surfaces of the receiving members. In embodiments, the corrosion resistant rails are stainless steel. In embodiments, the corrosion resistant receiving members are stainless steel. In embodiments the receiving members are tubular stainless steel. In embodiments, the receiving members are mounted above and on top of the floor contacting rails. In embodiments, the receiving members are welded to and are unitary with the plurality of corrosion resistant floor contacting rails. In embodiments, the receiving members are mounted on the floor and are welded to the plurality of floor contacting rails.

A feature and advantage of embodiments is that a known general placement of components, operational units, of a direct drive carpet cleaning system for a van, can be generally maintained by mounting the components, the operational units, on a stainless steel frame assembly that has a layout that extends about the footprints of the operational units, and has the multiple connection points, generally more than 20, that are necessary to secure the individual operational units, made between the various operational components and the stainless steel frame assembly, while the stainless steel frame assembly is secured with minimal connections, for example four to six, to the van floor. The savings in time, expense, the ease of installation, the reduction in repairs, the robustness of the arrangement, and even the increase in the useful life of the equipment including the van are all extraordinary.

Typically operational units are mounted to the truck or van floor with bolts extending through the floor and then through plates below the floor and then nuts with washers are attached. Inventors have learned that attempts to monitor and control corrosion at twenty plus bolt sites through a steel van floor is difficult if not impossible. A feature and advantage of embodiments is that only four or six holes through a cargo van floor are easily monitored and maintained for controlling corrosion.

A feature and benefit of embodiments is that the frame assembly described herein allows for greater accessibility to hoses and wiring not available with conventional installations, which would require removal of components.

A feature and benefit of embodiments is the frame assembly described herein further allows for easier and faster maintenance and adjustment of the direct drive connection to the pump and blower unit than with a conventional installation.

A feature and benefit of embodiments is that the removal of any one part of the cleaning system on the frame assembly can be done with one individual and 30 minutes of time.

A feature and benefit of embodiments is that the time that two people are required for installation of the carpet cleaning equipment is for less than one hour out of the total installation time.

A feature and benefit of embodiments is a that only four holes are needed in the vehicle floor for securement of the frame assembly the seats and secures the carpet cleaning equipment, making the vehicle far less susceptible to damage from corrosion originating at holes in the floor.

A feature and benefit of embodiments is that the weight of the components, including the water tanks, is much more evenly distributed across vehicle interior utilizing the mounting frame assembly compared to conventional installation, relieving stresses on the vehicle floor.

A feature and benefit of embodiments is that, with the frame assembly described herein, there are no holes drilled over the transmission tunnel of the vehicle for the blower assembly mount, which can weigh about 400 lbs, creating a weak spot for rust. In conventional carpet cleaning installations, there are such holes.

The inventors have discovered that the various operational units associated with carpet cleaning equipment, particularly direct drive equipment, do not need to be flush mounted with the vehicle floor over the entire footprint of each operational unit. Rather, for specific operational units, mounting these operational units only on the perimeter where the existing apertured mounting strips are located, provide more than adequate structural support. For certain operational units, just mounting the operational units by way of mounting strips on two opposite sides is adequate structural support. The frameworks of individual operational units are more than adequate for supporting the components of the operational units without support extending.

The inventors have discovered that in the case of a known hose reel and tank assembly, a frame member extending directly centrally below the operational unit is advantageous.

A feature and benefit of embodiments is that, with the frame assembly described herein, accumulated water or cleaning fluids are less likely to cause rust or damage to the vehicle. Moreover, with spacing between the operational units and the floor and equipment. Removing fluids on the floor of the vehicle is also easier.

A feature and benefit of embodiments is that, with the frame assembly described herein, equipment is elevated to prevent sitting in what can be highly corrosive water. This minimizes rust damage to the equipment, including the vehicle.

A feature and advantage of embodiments is that, with the frame assembly described herein, the total install time, start to finish, of the operational components of a direct drive carpet cleaning system may be one to two 2 days with one dedicated technician and one other technician helping for less than 1 hour. This compares to install times of approximately two weeks utilizing two technicians when the same operational equipment is mounted directly to the van floor.

A feature and benefit of embodiments is that, with the frame assembly described herein, installation of a direct drive carpet cleaning system in a van is faster, requires less man-power, increases technician safety and has the result of minimizing future repairs and extending the life of the equipment.

The above summary of the various representative embodiments is not intended to describe each illustrated embodiment or every implementation of the invention. Rather, the embodiments are chosen and described so that others skilled in the art can appreciate and understand the principles and practices of the invention. The Figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1A is a prior art perspective view of a direct drive truckmount cleaning system in a van. prior art

FIG. 1B is a plan view of a van with a carpet cleaning system with operational units directly mounted to the van floor.

FIG. 2 is a cross-sectional view of the prior art van floor with ribbing and operational units attached thereto.

FIG. 3 is a perspective view of a prior art carpet cleaning system operational unit including a vacuum recovery tank and a control panel.

FIG. 4 is a perspective view of the prior art operational unit of FIG. 3 from the side opposite of FIG. 3.

FIG. 5 is rear perspective view of a prior art blower pump operational unit.

FIG. 6 is a prior art perspective view of a prior art hose reel and tank operational unit.

FIG. 7 is a perspective view of a prior art auxiliary liquid tank.

FIG. 8 front perspective view of a mounting frame assembly in accordance with embodiments of the invention.

FIG. 9 is a perspective view of a mounting frame forward extension.

FIG. 10A is a perspective view of an elevating framework for a water tank.

FIG. 10B is an auxiliary water tank operational unit with mounting strips.

FIG. 11 is a perspective view of a frame mounting assembly for attachment of four carpet cleaning operational units.

FIG. 12 is a plan view of a cargo van with a frame assembly mounted therein.

FIG. 13 is a cross sectional view of an attachment of a mounting frame to a ribbed steel floor of a van.

FIG. 14 is a cross sectional view through the floor showing an elevational view of a operational unit to the frame in accord with embodiments.

FIG. 15 is a top plan view of the cargo van of FIG. 12 with four operational units installed on the frame mounting assembly.

FIG. 16 is a perspective view of operational units installed on the mounting frame assembly of FIG. 11.

FIG. 17 is a detail perspective view of the blower pump unit on the forward extension of the mounting frame assembly.

FIG. 18 is a perspective view of another frame assembly with three zones for operational units.

FIG. 19 is a perspective view of another frame assembly with two zones for operational units.

While the invention is amenable to various modifications and alternative forms, specifics thereof have been depicted by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

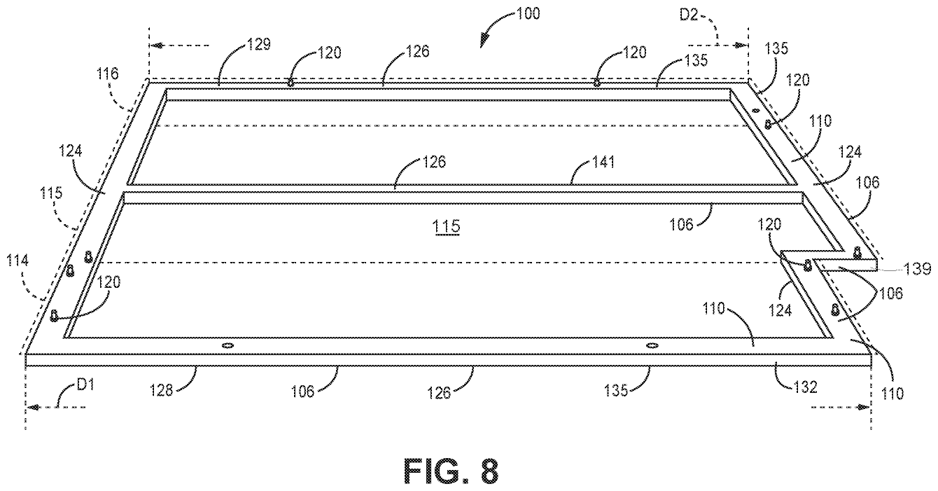

Referring to FIGS. 8-11, mounting frame assemblies and components thereof are illustrated for mounting in trucks or vans and that are configured to receive operational units of carpet cleaning systems. In embodiments, a plurality of stainless steel tubing members and/or bars are precut and welded together into a first main mounting frame 100. In embodiments, the rectangular tubing is 1 inch×2 inches and the solid bars are ½ by 2 inches. The frame members are unitary with each other by way of the welding. The linear frame portions 106 have coplanar top surfaces 110. The mounting frame 100 is configured for receiving specific operational units in mounting zones 114, 115, 116 as illustrated by the dashed lines of FIG. 8. The mounting frame 100 is fabricated for securing with threaded fasteners each of the operational units by way of seating and attaching the mounting strips 90 of the operational units to the planar horizontal top surface 110 of the mounting frame 100. The positioning of the threaded fasteners is part of the fabrication process pre installation into the vehicle. In the embodiment depicted, the threaded fasteners 120 comprise threaded studs 120 fixed to the frame portions, such as by welding, and extend upwardly to be received in specific existing holes of the mounting strips of the intended operational unit to be mounted at that location. Alternately, threaded nuts or threaded holes in the respective sites of the frame portions could also be utilized.

Referring to FIG. 8, in embodiments, the first main mounting frame 100 has forward-rearward linear frame portions 124 and crossing linear frame portions 126, including a forwardmost frame portion 128 and a rearwardmost frame portions 129. The frame portions are planarly arranged providing the planar top surface 110 defining a main datum level for receiving operational units and a planar bottom surface 132 for seating on the floor ribbing. The perimeter frame portions 135 defining a closed geometric figure configured as a polygonal shape when viewed from above defining a polygonal cell. The middle crossing member 133 dividing said figure into two additional polygonal shapes of polygonal cells.

The distance D1 of zone 1 defined by the width of the frame is essentially equal to the length of the mounting footprint of the intended operational unit to be installed, in this case the vacuum recovery tank unit 74. In embodiments D1 is about 52 inches. The mounting footprint 136 illustrated on FIG. 4 is defined by the outer periphery of the apertured mounting strips 90, in this case, the mounting flanges. The second zone 115 is configured for the hose reel and storage tank unit 80 which has a mounting footprint 137 which is greater than the length of the mounting footprint of the vacuum recovery tank unit accounting for the jog 139 in the port side of the frame assembly 100. The width of the mounting zone D2 is about 54 ½ inches which equates to the length of the reel and tank operational unit 80. Due to the significant weight of the tank when filled with liquid, a tank load carrying crossing member 141 is positioned directly below and centralized to the tank for supporting said weight. The third zone is for receiving an elevated auxiliary tank unit discussed below.

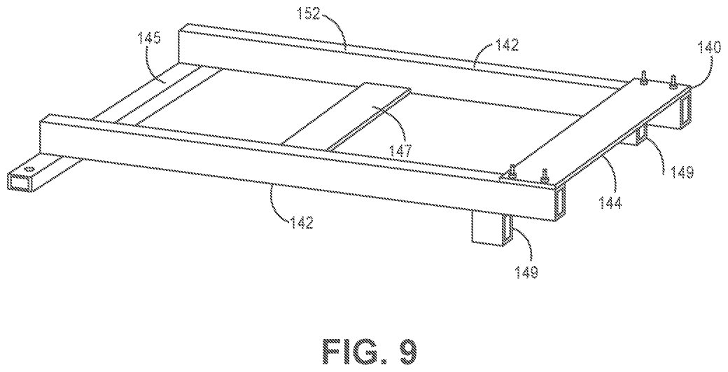

Referring to FIG. 9, an additional mounting frame assembly configured as a mounting frame forward extension 140 is illustrated and has two forwardly extending beam frame portions 142, a forward crossing frame portion 144, a rearward mounting crossing frame portion 145, a bridging seating frame portion 147, and feet 149. This frame assembly is configures to be attached to the forwardmost crossing frame portion 128 of a main mounting frame 100, such as is shown in FIG. 8. The forward extension is configured to receive a blower pump unit 70 and to position the blower pump unit in-between the passenger and driver seats. The forward extension 140 is configure to raise the datum level of the blower pump unit several inches above datum level defined by the top surface of the first main mounting frame 100. The inventor has found that this provides more optimal positioning with transferring power by way of the driveshaft 68 and further elevates the engine from the floor and eliminates the need for mounting holes in proximity to the van transmission positioned below this location. The weight of the blower pump assembly distributed to the van floor by the forwardmost crossing frame portion 128 and the two feet. The forward extension 140 may be bolted on or welded on to the

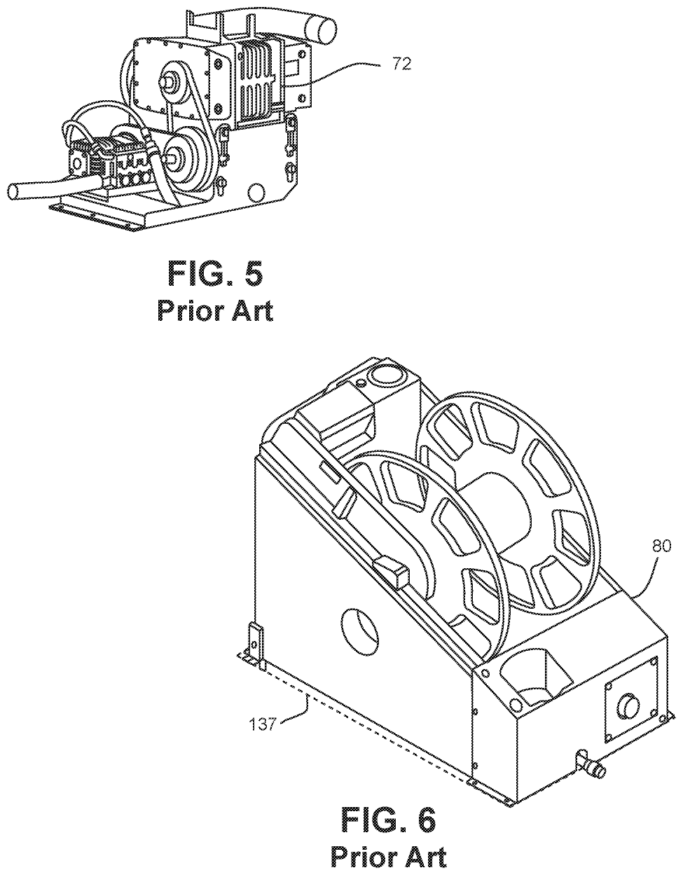

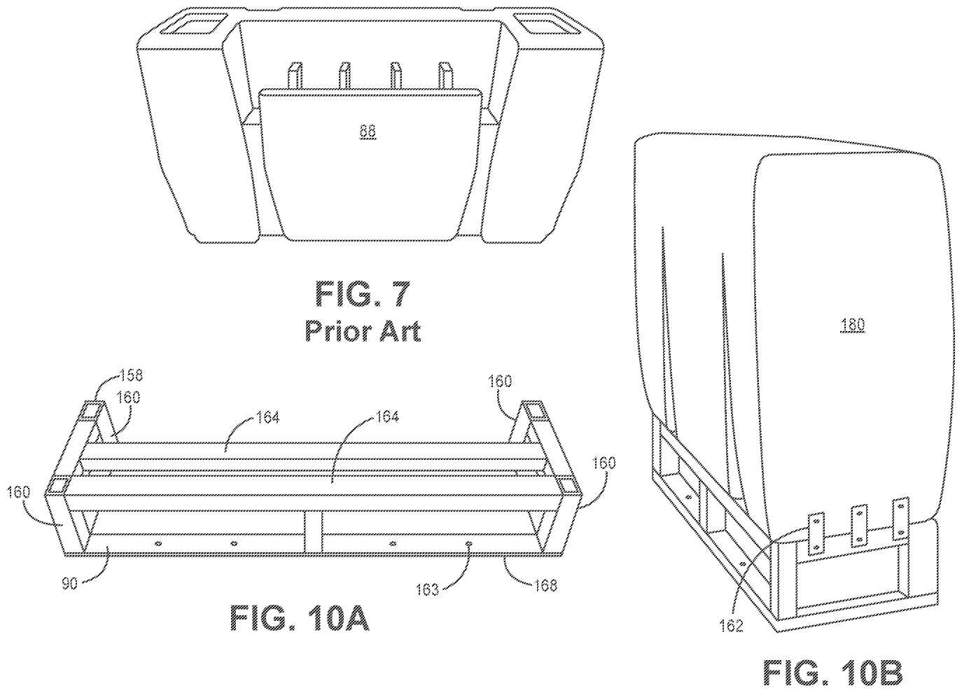

Referring to FIG. 10A, an elevating tank mounting frame 158 is illustrated for mounting the prior art tank 88 of FIG. 5. In embodiments, the frame is comprised primarily of 2 inch×2 inch stainless steel tubing sections. Four posts 160 and four horizontal frame portions 164 of the tubing are welded together on a 1 inch×2 inch solid stainless steel bars forming a base 168. Apertures 170 are added to the base. The mounting footprint 174 of the auxiliary tank corresponding to the upwardly facing planar mounting surfaces 178 of the frame 158. The prior art tank of FIG. 7 may then be mounted on the frame 158 as illustrated in FIG. 10B by way of brackets 162. The 1 inch by 2 inch base with apertures 163 then define a mounting strip 90 and the assembled frame and tank is an operational unit, specifically an auxiliary tank unit 180, for the carpet cleaning system that may be added to the main mounting frame 100 along with the other operational units.

In embodiments, the main mounting frame 100 and frame portions thereof may comprise 1″×2″ rectangular tubes. In embodiments, the 2″ side of the rectangular tubes may comprise the top surface 110. In embodiments, the 1″ side of the rectangular tubes may comprise the top surface 152 of the frame forward extension 140. In embodiments, the main mounting frame portion 100 and beams thereof may comprise 2″×2″ square tubes. In embodiments, the main frame portion 100 and beams thereof may comprise a combination of 1″×2″ rectangular tubes and 2″×2″ square tubes. In embodiments, the rectangular and square tubes and bars may be # 304 stainless steel. In embodiments, certain frame portions may comprise C channel or U channels. In such embodiments, the frame portions can have apertures aligned with the holes of the apertured mounting strips of the operational units, allowing a bolt to extend through the aligned apertures and a nut can be attached to the bolt. The C channel or U channels may be stainless steel. In other embodiments the frame may be attached to the van floor by welding such that there no need to penetrate the van floor. Brackets may be welded to the floor that are then removably attachable to the mounting frame (not show).

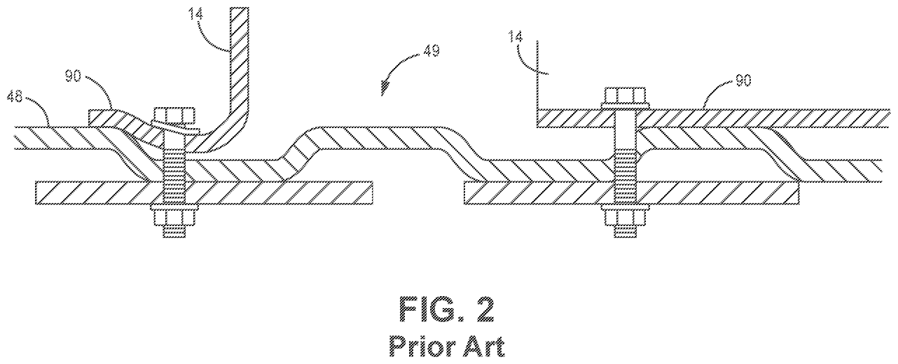

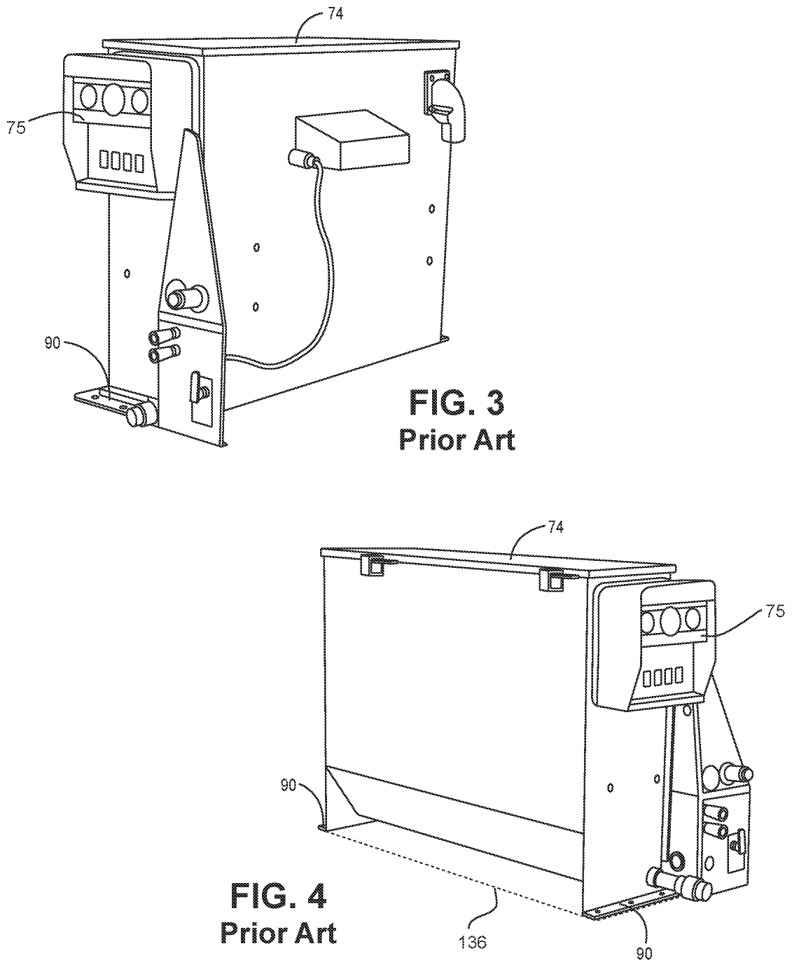

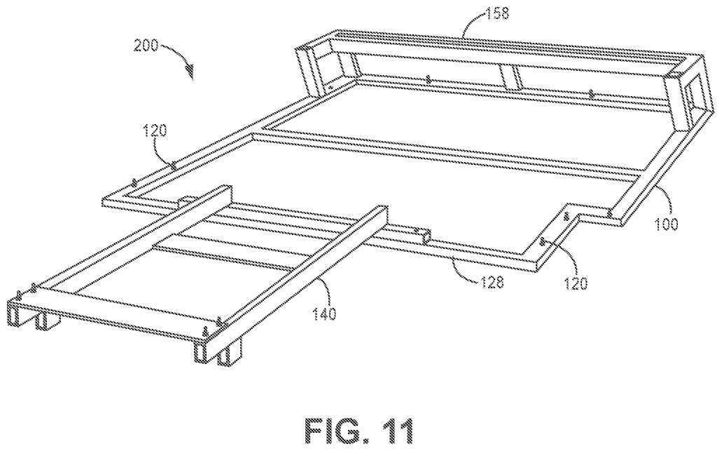

Referring to FIG. 11, a mounting frame assembly 200 is illustrated and includes the main mounting frame 100, the mounting frame forward extension 140 attached to the forward most crossing member 128, and the elevating tank mounting frame 158 is mounted on the rearward end portion 204 of the main frame. Threaded studs 120 are positioned to be aligned with the apertures of the mounting strips, such as flanges, of the operational units. The specific units may be such as is portrayed in FIGS. 2A-5.

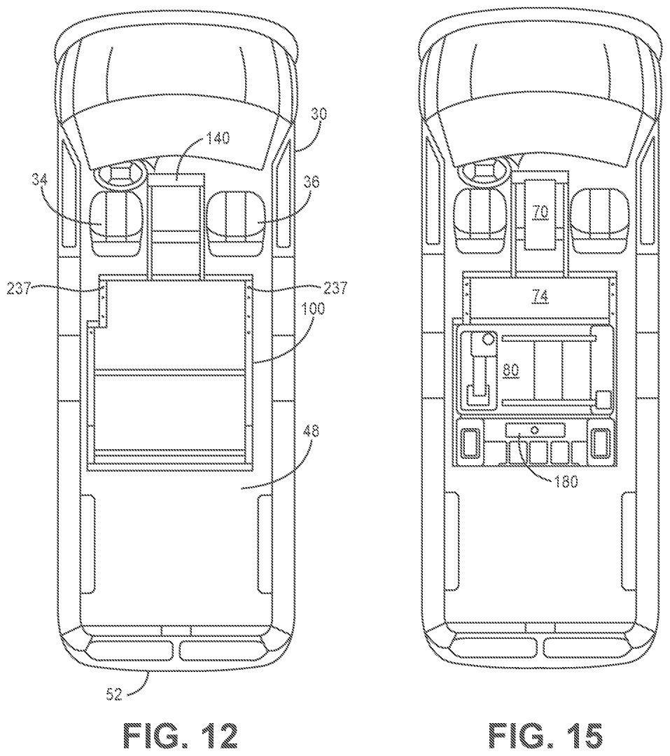

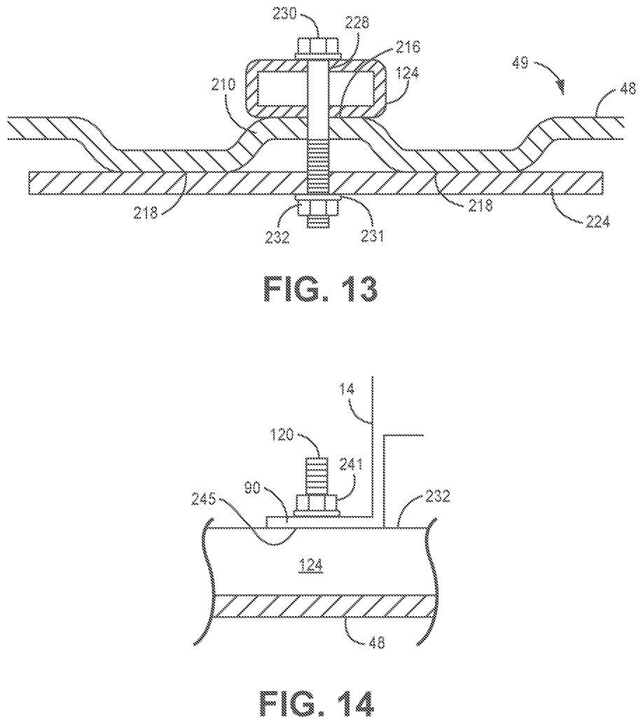

Referring to FIGS. 12 and 13, in embodiments, the mounting frame assembly 200, at least the main frame and forward extension would typically first be mounted in the van on the cargo box floor before the operational units are installed thereon. The frame may be inserted through the rear access door and positioned as depicted in FIG. 12 with the forward extension 140 that receives the blower pump unit positioned between the passenger and driver's seat 34, 36. A suitable attachment method of the frame assembly 200 to the van ribbed floor is illustrated by FIG. 13. A forward-rearward frame portion 124 may be positioned over a raised region 210 of the ribbed floor 48 with ribbing 49 such that the planar lower facing surface 214 of the rectangular tubing contacts an upwardly facing surface 216 of the ribbed floor. A hole 220 may be drilled through the rectangular tubing and through the ribbed floor. A plate 224 with a central hole 226 of sufficient size to engage a plurality of the downward facing ribs 218 is positioned below the drilled hole. A plate with a diameter or width of 8 inches is suitable. A bolt 230 is inserted through the aligned holes and is secured with a washer 231 and nut 232. Sealer such as silicon 233 can be used to seal the hole and cover the exposed metal of the floor due to the drilling of the hole.

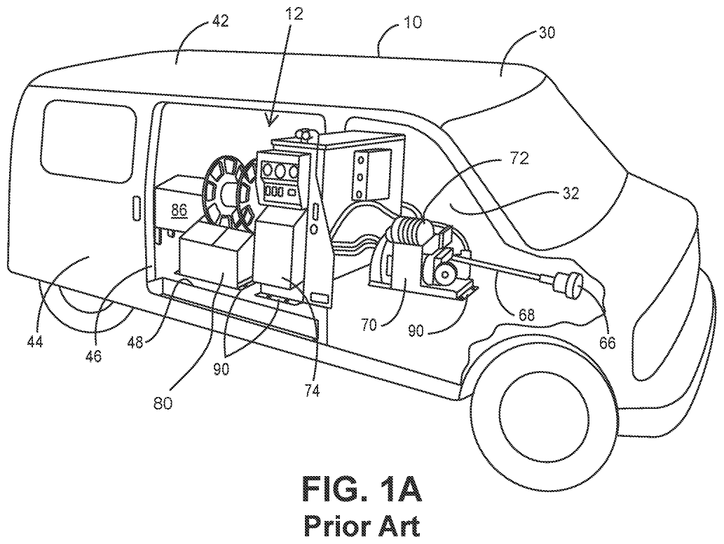

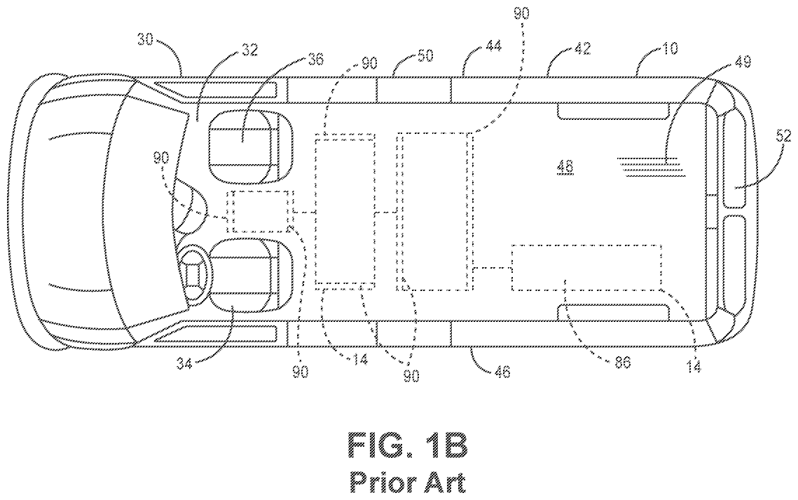

The above attachment of the mounting frame can be compared with the prior art method of FIG. 1C where due to the multiplicity of holes needed to attach each individual operational unit, the hole position cannot be controlled or adequately selected resulting in less than ideal connections. Suitably, the main frame 100 may have attachments 237 with four bolt and nut combinations approximately at the corners of the main frame compared to the multiplicity, typically 20 or more, needed for the conventional attachment of the individual operational units to the floor.

Once the frame assembly is installed, the operational units, such as portrayed in FIGS. 2A to 5, the blower pump unit 70, the vacuum recovery tank unit 74, the hose and liquid storage tank unit 80, may be installed. In embodiments, the units are carried into the cargo area, are positioned over the zone where the unit is to be installed and is lowered such that apertures in the mounting strip, are aligned with the upwardly projecting threaded studs, the unit is seated on the upper surface of the mounting frame with the stud extending through the aperture in the respective mounting strip, washers and nuts 241 are attached to the studs securing the unit in place. See FIG. 14. The planar mounting surface 243 of the frame portion receives the lower planar mounting surface 245 of the apertured mounting strip 90 for a robust connection. Compare this to the issues illustrated in the conventional attachment of FIG. 1C.

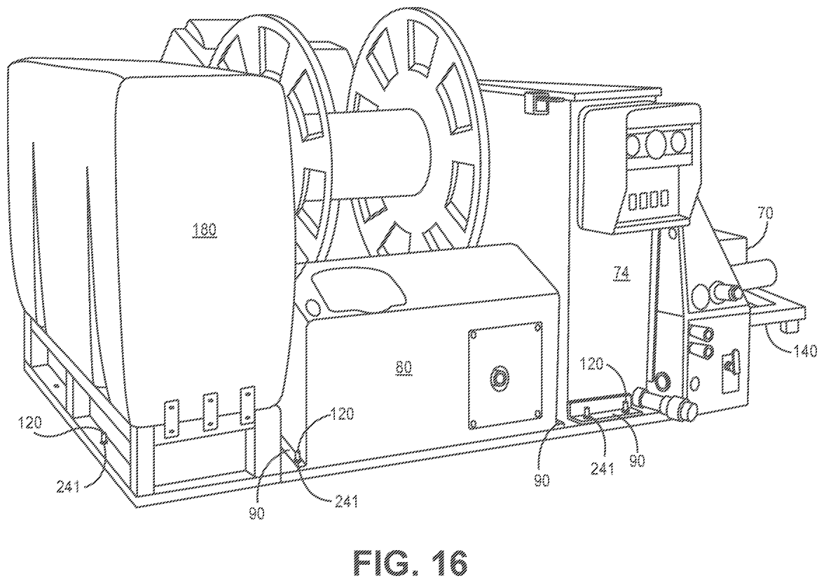

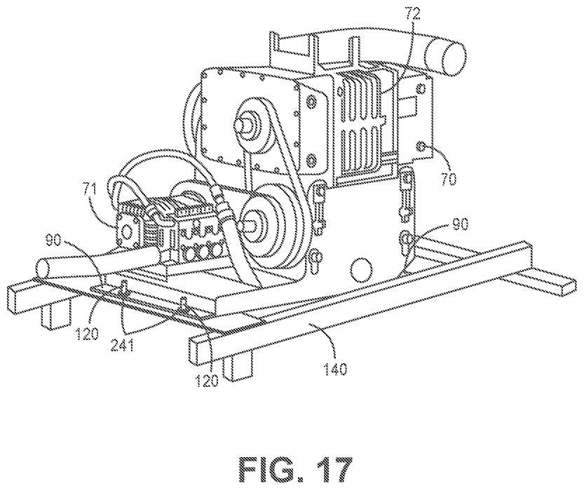

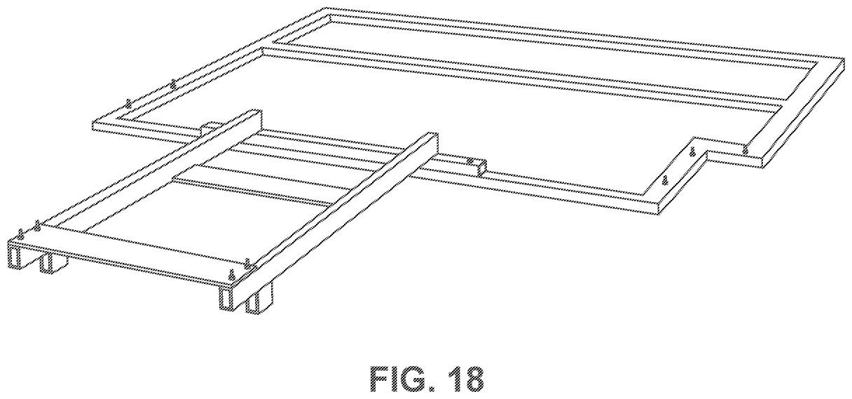

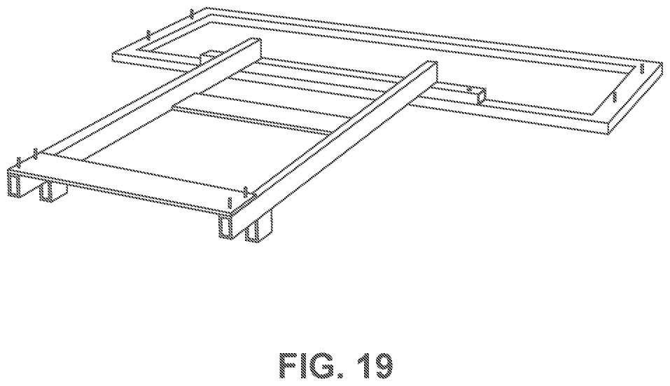

Referring to FIGS. 15, 16, and 17, the operational units are secured to the mounting frame assembly 200. FIG. 17 shows detail of the blower pump unit mount not visible from the view of FIG. 16. Appropriate wiring and connections are made and the van with the carpet cleaning system 260 is complete and ready for deployment. The operational units may be readily accessed, serviced and removed through either the cargo van side door or rear access door.

In embodiments, the blower pump unit 70 may be mounted on the forward extension 140 prior to positioning the mounting frame assembly 200 in the vehicle. An example of a blower pump unit as depicted is available from Hydramaster Corporation, Mukilteo, Wash. In embodiments, installing and securing the mounting frame assembly 200 and the blower pump unit may take about 1 hour.

In contrast, installation of a blower assembly using conventional methods requires locating the proper place for the blower assembly on vehicle floor; drilling four holes in the vehicle floor and mounting two brackets, typically ¼ inch steel brackets; mounting the blower assembly on top of two brackets and aligning the driveshaft using an engine hoist; and bolting the top blower bracket to the installed brackets. The conventional methods typically take about four hours and require two people.

An example of a hose and tank assembly 80 is Hydra-Master's CDS Hydra Cradle tank. In embodiments, installing and securing a hose and tank unit may take one person about 15 minutes.

In contrast, installation of a hose and tank assembly using conventional methods requires: sliding the tank into place and measuring and marking distances for holes; drilling eight individual holes in the floor of the vehicle for mounting; bolting down and securing the tank in place using small tabs and bolts usually provided in a kit. Conventional methods typically takes about 1-2.5 hours and requires two people.

An example of a vacuum recovery tank unit 74 is available from Hydramaster Corporation, Mukilteo, Wash. In embodiments, installing and securing a recovery tank unit as described herein may take two people to move the tank and one to install and about 15 minutes.

In contrast, installation of the vacuum recovery tank unit 74 using conventional methods requires: sliding the tank in the side door of the vehicle; measuring and marking five holes to be drilled in vehicle floor; drilling and installing bolts and brace provided in an installation kit. Installation typically requires about 1-2 hours and requires two people to install.

In embodiments, installing and securing the auxiliary tank unit 180 may require two people and take about 15 minutes.

In contrast, installation of a water tank using conventional methods requires: mounting the tank on a frame or directly on the floor of the vehicle; placing the tank in the vehicle and marking positions for six mounting holes for drilling; removing the tank and drilling the six holes; reinstalling the tank; bolting the tank down with the six bolts in the vehicle floor; and installing a back support bracket for the tank to minimize the weight tipping it over. Installation typically requires 2 people and takes about 2-3 hours.

With the frame assembly described herein, weight is evenly distributed across vehicle interior. Whereas, for conventional installations, there is no weight distribution for full water tanks. Each tank of the various assemblies presses on the thin floor of the vehicle. The many bolts required to secure the individual assemblies serve to provide further uneven pressure on the floor of the vehicle.

With the frame assembly described herein, there are no holes drilled over the transmission tunnel of the vehicle for the blower assembly mount, which can weigh about 400 lbs, creating a weak spot for rust.

With the frame assembly described herein, there is minimal area for water to accumulate and cause rust or damage to vehicle and equipment. Whereas, conventional installations allow for multiple locations for water to sit and rust the vehicle from inside out. Over time this can pose hazards from rust holes in floor of vehicle.

With the frame assembly described herein, the total install time, start to finish, may be one to two 2 days with one dedicated technician and one helping for less than 1 hour. Whereas, for conventional installations, the average time to install a full working system is about one week with two dedicated technicians.

With the frame assembly described herein, installation of a DDTCS is faster, requires less man-power, decreases damage to the vehicle and materials and increases technician safety.

The following United States patents and patent publications are hereby incorporated by reference herein in their entirety except for patent claims and express definitions contained therein: U.S. Pat. No. 7,208,050; U.S. Pat. No. 6,675,437; U.S. Pat. No. 6,625,844; U.S. Pat. No. 5,469,598; U.S. Pat. No. 5,430,910; U.S. Pat. No. 5,095,578; U.S. Pat. No. 4,949,424; U.S. Pat. No. 4,940,082; U.S. Pat. No. 4,336,627; U.S. Pat. No. 4,284,127; U.S. Pat. No. 4,207,649; U.S. Pat. No. 3,774,261; US20100294459; US20100024242; US20080035304; 20050278889; US20040134649; US20040118439; US20030229963. Components illustrated in the incorporated by reference references may be utilized with embodiments herein. Incorporation by reference is discussed, for example, in MPEP section 2163.07(B).

All of the features disclosed, claimed, and incorporated by reference herein, and all of the steps of any method or process so disclosed, may be combined in any combination, except combinations where at least some of such features and/or steps are mutually exclusive. Each feature disclosed in this specification may be replaced by alternative features serving the same, equivalent or similar purpose, unless expressly stated otherwise. Thus, unless expressly stated otherwise, each feature disclosed is an example only of a generic series of equivalent or similar features. Inventive aspects of this disclosure are not restricted to the details of the foregoing embodiments, but rather extend to any novel embodiment, or any novel combination of embodiments, of the features presented in this disclosure, and to any novel embodiment, or any novel combination of embodiments, of the steps of any method or process so disclosed.

Although specific examples have been illustrated and described herein, it will be appreciated by those of ordinary skill in the art that any arrangement calculated to achieve the same purpose could be substituted for the specific examples disclosed. This application is intended to cover adaptations or variations of the present subject matter. Therefore, it is intended that the invention be defined by the attached claims and their legal equivalents, as well as the illustrative aspects. The above described embodiments are merely descriptive of its principles and are not to be considered limiting. Further modifications of the invention herein disclosed will occur to those skilled in the respective arts and all such modifications are deemed to be within the scope of the inventive aspects.

What is claimed is:

1. A cargo van with a carpet cleaning system mounted therein with a corrosion resistant mounting system, the cargo van having a cargo box with a cargo floor, the cleaning system comprising at least three discrete operational units, each operational unit having a mounting footprint, the plurality of operational units in combination providing carpet cleaning functions including: pumping and dispensing of cleaning fluid away from said cargo van, vacuum recovery of used cleaning fluid collected away from said cargo van, storage of cleaning fluid before dispensing, and storage of recovered cleaning fluid after recovery;
each of the said carpet cleaning functions associated with one of the at least three operational units, and wherein each of the operational units has a bottom mounting portion comprising mounting strips or tabs on opposing sides of each of the operational units;
The corrosion resistant mounting frame assembly being attached to the floor and having each of the operational units secured thereto, the mounting frame assembly having a polygonal shaped mounting frame portion when viewed from above, the polygonal shaped mounting frame portion comprising a plurality of corrosion resistant stainless steel frame portions welded together into a unitary mounting assembly, each of the frame portions having a lower horizontally extending stainless steel portion having a thickness with a flat or planar exposed lower surface confronting the van floor and an upper horizontally extending stainless steel portion having a thickness with a flat or planar upper surface for seating of the operational units thereon, the upper horizontally extending stainless steel portion spaced from the lower horizontally extending stainless steel portion, the polygonal mounting frame portion spanning most of an inside side-to-side distance of the cargo box, the polygonal shaped mounting frame portion being attached to said cargo floor; and
wherein the plurality of the operational units spanning across polygonal shaped mounting frame portion from side to side and being attached thereto with stainless steel threaded fasteners positioned at the respective mounting strips or tabs of the operational units whereby there is spacing between the mounting strips or tabs of the plurality of operational units and the cargo floor defined bottom provided by the thickness of the frame portions on which the operational units are mounted including the thickness of the lower horizontally extending stainless steel portion, the thickness of the upper horizontally extending stainless steel portion, and by the spacing between the upper horizontally extending stainless steel portion and the lower horizontally extending stainless steel portion.

2. The cargo van with the carpet cleaning system of claim 1, wherein each of the plurality of corrosion resistant stainless steel frame portions comprise stainless steel tubing.

3. The cargo van with the carpet cleaning system of claim 2, further comprising at least one stainless steel frame portion that is not configured as tubing.

4. The cargo van with the carpet cleaning system of claim 1, wherein each of the plurality of operational units secured to the polygonal mounting frame portion are secured to at least two opposing sides of the mounting footprint of each operational unit.

5. The cargo van with the carpet cleaning system of claim 1 wherein each of the threaded fasteners attaching the plurality of operational units to the polygonal mounting frame portion comprise threaded stainless steel studs that are welded to and unitary with the polygonal shaped mounting frame portion and extending upwardly therefrom and securing the mounting strips or tabs of the respective plurality of operational units.

6. The cargo van with the carpet cleaning system of claim 2, wherein the operational units are spaced from the floor by more than 1 inch.

7. The cargo van with the carpet cleaning system of claim 1, wherein the mounting frame assembly is attached to the cargo floor with not more than six threaded fasteners extending from the polygonal mounting frame portion through the cargo floor.

8. The cargo van with the carpet cleaning system of claim 1, wherein each of the operational units is removable from the van without unfastening any threaded fasteners extending through the cargo van floor.

9. The cargo van with the carpet cleaning system of claim 1, wherein the frame portions of the polygonal mounting frame portion have a vertical dimension of between ¾ inches and 2 inches whereby the plurality of operational units mounted on the polygonal mounting frame portion are elevated about the cargo floor about ¾ to 2 inches.

10. The cargo van with the carpet cleaning system of claim 1, wherein the mounting frame assembly comprises a forwardmost polygonal mounting frame extension sized to receive an operational unit comprising a blower and pump, the forwardmost polygonal mounting frame extension positioned between a driver's seat and a passenger seat, the operational unit comprising the blower and pump attached thereto with threaded fasteners, the forward most polygonal mounting frame portion not attached to the van by way of fasteners extending from the polygonal mounting frame portion through a floor of the van.

11. The cargo van with the carpet cleaning system of claim 10, wherein the forward most mounting frame extension has a top surface defining a mounting datum level that is elevated from the top surface of the polygonal mounting frame portion.

12. A van with a carpet cleaning system mounted to the van with a corrosion resistant mounting system, the van having a forward cab with a driver seat and a passenger seat in a cab interior, a cargo box rearward of the cab and open to the cab interior, the cargo box defining a cargo area, the cargo box including a cargo box floor, opposite cargo box side walls, a port side access door, a rear cargo access door, a cargo area floor and with a floor cleaning system mounted to the cargo floor on a stainless steel tubular frame assembly;
wherein the floor cleaning system comprises a plurality of operational units, the operational units comprising:
a pump blower unit with at least one lower horizontal apertured mounting flange or bracket;
a vacuum recovery tank unit with rectangular mounting footprint having a pair of mounting flanges or brackets on opposing shorter sides of the footprint; and
a hose reel and tank unit with a rectangular mounting footprint with mounting brackets or flanges at the mounting foot print;
wherein the stainless steel tubular frame assembly comprises:
a plurality of forward-rearward extending stainless steel frame portions, a plurality of stainless steel crossing frame portions unitary with the forward-rearward frame portions, each of the forward-rearward extending stainless steel frame portions having coplanar flat floor contacting surfaces and coplanar top flat operational unit mounting surfaces, the frame assembly defining a plurality of closed geometric shapes when viewed from above, the frame assembly positioned on the cargo box floor and attached with four bolts extending through the frame assembly and through the cargo box floor;
wherein each of the operational units are mounted on the frame assembly by stainless steel threaded fasteners and are not directly mounted on the cargo box floor and wherein the pump blower unit and the vacuum recovery tank unit are seated and attached with the stainless steel threaded fasteners on the coplanar top flat operational unit mounting surfaces of the plurality of stainless steel frame portions.

13. The van with the carpet cleaning system of claim 12, wherein each of the operational units is elevated by the frame assembly at least 0.75 inches but not more than 2.5 inches above the cargo box floor.

14. The van with the carpet cleaning system of claim 12, wherein each of the operational units is elevated by the frame assembly at least 0.75 inches but not more than 2.5 inches above the cargo box floor.

15. The van with the carpet cleaning system of claim 12, wherein the mounting frame assembly comprises a mounting frame portion extending forward between the driver seat and the passenger seat comprising a pair of forward-rearward extending stainless steel frame portions and a crossing stainless steel frame portion and wherein the blower pump unit is mounted on said mounting frame portion.

16. The van with the carpet cleaning system of claim 15, wherein said mounting frame portion extending forward between the driver seat and the passenger seat is not secured to the cargo van floor with threaded fasteners extending through said mounting frame portion and the cargo van floor.

17. The van with the carpet cleaning system of claim 12, wherein each of the operational units is elevated by the frame assembly at least 0.75 inches but not more than 2.5 inches above the cargo box floor.

18. The van with the carpet cleaning system of claim 12, wherein the operational units further comprise an auxiliary liquid tank unit with a mounting foot print with greatest dimension of the mounting footprint being equal to the side to side greatest dimension of the mounting frame assembly.

19. The van with the carpet cleaning system of claim 12, wherein one of the forward rearward extending stainless steel frame portions is positioned in proximity to the side wall on the driver's side and another one of the forward-rearward extending stainless steel frame portions is positioned adjacent the side access door on the passenger's side, and wherein the one and the another one are spaced to be equal to the greatest dimension of the vacuum recovery tank unit mounting footprint and the greatest dimension of the hose and reel unit.

20. A van with a corrosion resistant stainless frame assembly that supports and secures a floor cleaning system in the cargo area of the van the corrosion resistant stainless steel frame assembly comprising:
a plurality of stainless steel frame members welded together defining a frame assembly having a plurality of polygonal shaped cells defined by the frame assembly when viewed from above, the frame assembly having a width and a length, the width sized to extend most of the distance between side walls of a van cargo box, and further sized to receive operational components of the floor cleaning system such that each operation component spans the frame assembly in the width wise direction, the stainless steel frame member having a plurality of threaded studs extending upwardly from a top surface of the frame member positioned to be received in mounting holes of the operational units of the floor cleaning system,
wherein the plurality of stainless steel frame members comprise stainless steel tubing with a rectangular cross section.
